(19) United States
(12) Patent Application Publication
(10) Pub. No.: US 2011/0265621 A1
(43) Pub. Date: Nov. 3, 2011

(54) Profile Loaf Cutting System for Food Products

(76) Inventor: Richard F. Schmidt, Fond du Lac, WI (US)

(21) Appl. No.: 12/770,103

(22) Filed: Apr. 29, 2010

(51) Int. Cl. B26D 7/27; B26D 1/547; A47J 43/04; B26D 3/00; B26D 7/32

(52) U.S. Cl. 83/35; 83/39; 83/404; 99/537

(57) ABSTRACT

A system for cutting blocks of food product into individual, elongated loaves of substantially equal size. The system includes a loaf cutter conveyor configured to receive incoming blocks of food product and move the blocks along continuum processing path for cutting; a programmable logic controller coupled to the loaf cutter conveyor; and, multiple stations associated with the cutter conveyor. The PLC is configured to determine an optimized cut solution of the slab portion of food product from data related to the food product, and is configured to provide the cut solution to the various stations. The PLC is configured to control the system for cutting of the food product, based on the optimized cut solution, into loaves of substantially equal size and shape.

### BACKGROUND

### Field of the Invention

The present invention relates generally to food processing, and more particularly to a conveyor system configured to optimize a cut solution to maximize the output of a food product from a bulk size block to profile individual loaves.

Many food products, such as cheese, are produced in block form and a multi-stage cutting operation is used for cutting the blocks into smaller portions for retail sale. In conventional systems of cutting large blocks of cheese, or other food products, the cheese is cut into a plurality of strips and then cut into small pieces. Such conventional systems produce as much as 15% of waste, i.e. not suitable for retail sale, and also result in giveaway of product of as much as 1% over a target weight of acceptable retail product. The system disclosed herein maximizes the yield from a specific slab of food product to result in less than 10% of waste and not more than ½% of giveaway over a specific target weight of food product, resulting in the maximum number of individual bars of food product of substantially equal weight from the original block of food product.

The apparatus of the present disclosure must be of construction which is both durable and long lasting, and it should also require little or no maintenance to be provided by the user throughout its operating lifetime. In order to enhance the market appeal of the apparatus of the present disclosure, it should also be of inexpensive construction to thereby afford it the broadest possible market. Finally, it is also an objective that all of the aforesaid advantages and objectives be achieved without incurring any substantial relative disadvantage.

### SUMMARY

The disadvantages and limitations of the background art discussed above are overcome by the present disclosure.

There is disclosed a system for cutting blocks of food product into individual, elongated loaves. The system includes a loaf cutter conveyer configured to receive incoming blocks of food product and move the blocks along a continuum processing path for cutting. The system also includes a programmable logic controller coupled to the loaf cutter conveyor and a plurality of stations associated with the loaf cutter conveyor with each station coupled to the programmable logic controller. The stations include a slab cutter station configured to cut a slab portion from a block of food product. A slab measuring station is configured to determine a length of a side of the slab portion of food product. An indexing station is configured to position the slab portion. A loaf cutter station is configured to cut the slab portion into a preselected number of elongated loaves of substantially equal width, and a transport conveyor is configured to move the elongated loaves away from the loaf cutter station. The programmable logic controller is configured to control the cutting of the food product into individual elongated loaves of substantially equal width. In another embodiment, the system for cutting blocks of food product includes a staging platform aligned with the transport conveyor and configured to receive the plurality of elongated loaves of food product. A profile cutter station is coupled to the staging platform, with the profile cutter station including a loaf conveyor and a cutter holder positioned traverse to the loaf conveyor. A profile cutter is disposed in the cutter holder. A second staging platform is coupled to the profile cutter station and configured to receive profile cut elongated loaves of food product. The loaf conveyor is configured to move, simultaneously, the plurality of elongated loaves through the profile cutter to cut each elongated loaf into at least two profile cut elongated loaves and onto the second staging platform. In another embodiment, the system for cutting blocks of food product provides that the cutter is one of a diagonal cutter and a vertical cutter.

There is further provided a system for cutting blocks of food product into individual, profile elongated loaves. The system includes a conveyor system configured with a plurality of stations and platforms, with a station each to cut a slab portion, measure the length of the side of a slab portion, position the slab portion, cut the slab portion into a plurality of elongated loaves of substantially equal width, stage the elongated loaves, cut the elongated loaves into a preselected profile with a removable cutter, and move the profile cut elongated loaves. A programmable logic controller is coupled to the conveyor system and configured to control each of the stations and platforms. The programmable logic controller is also configured to determine the width of each profile cut elongated loaf based on the length of the side of the slab portion of food product in a predetermined number of desired loaves. Each of the profile cut elongated loaves is substantially the same width.

There is additionally provided a process for automating cutting of a block of food into individual elongated loaves on a conveyor system. The system includes an in-feed conveyor, a wire harp cutter, an indexing platform, and a guillotine cutter. The process includes moving a food block on the in-feed conveyor to the wire harp cutter indexing the food block in the wire harp cutter a preselected distance. The process also includes cutting a slab of the food block at the index distance and rotating the slab 90° onto the indexing platform. A sensor determines a slab width dimension of the slab and transmits the slab width dimension to a programmable logic controller coupled to the conveyor system. A guillotine cutter cuts the slab into a preselected number of elongated loaves, with each loaf having a loaf width dimension equal to the slab width dimension divided by the preselected number of elongated loaves. The elongated loaves are moved to a cutting station wherein the process of automating cutting of the block of food is controlled by the PLC. The PLC includes a database storing the pre-selected distance, the pre-selected number, and the slab with dimension. In another embodiment, the process for automating cutting of a block of food includes moving the elongated loaves to a staging platform coupled to the cutting station. A cutter holder is positioned traverse to a longitudinal access of the elongated loaves and a cutter is inserted into the cutter holder. The elongated loaves are moved through the cutter to a second staging platform wherein each elongated loaf is cut in a preselected profile.

There is further provided a process for automating cutting of a block of food into individual elongated loaves on a conveyor system. The conveyor system includes an in-feed conveyor, a wire harp cutter, an indexing platform, and a guillotine cutter. The process includes moving a food block on the in-feed conveyor to the wire harp cutter. In the wire harp cutter the food block is indexed a preselected distance and the slab of food block is cut at the index distance. The slab of food block is then rotated 90° onto the indexing platform with a sensor determining a slab width dimension of the slab. The slab width dimension is transmitted to a programmable logic controller coupled to the conveyor system. A guillotine cutter cuts the slab into a preselected number of elongated loaves, with each loaf having a loaf with dimension equal to the slab width dimension divided by the preselected number of elongated loaves. The cut elongated loaves are moved to a staging platform coupled to the cutting station. A cutting holder that is coupled to the cutting station receives a cutter with the cutter positioned traverse to a longitudinal axis of elongated loaves. The elongated loaves are moved through the cutter wherein each elongated loaf is cut in a preselected profile. Each of the profile cut elongated loaves is moved to a second staging platform. The process of automating cutting of a block of food is controlled by the PLC with the PLC including a database storing the pre-selected distance, the pre-selected number, and the slab width dimension.

The apparatus of the present disclosure is of a construction which is both durable and long lasting, and which will require little or no maintenance to be provided by the user throughout its operating lifetime. The apparatus of the present disclosure is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present disclosure are best understood with reference to the drawings, in which:

FIG. 1 is a perspective illustration of an exemplary embodiment of a system for cutting blocks of a food product into individual, profile loaves of substantially equal size.

FIG. 2 is a perspective illustration of the system of FIG. 1 rotated 90° from the aspect illustrated in FIG. 1.

FIG. 3 is a perspective illustration of the system of FIG. 2 illustrating a first position and second position (broken lines) of the exit conveyor of the system

FIG. 4 is a schematic block diagram of an exemplary embodiment of a control scheme of the system illustrated in FIG. 1.

FIG. 5 is a partial, perspective schematic illustration of an exemplary embodiment of a profile loaf cutting system illustrated in FIG. 1 including a diagonal cutter.

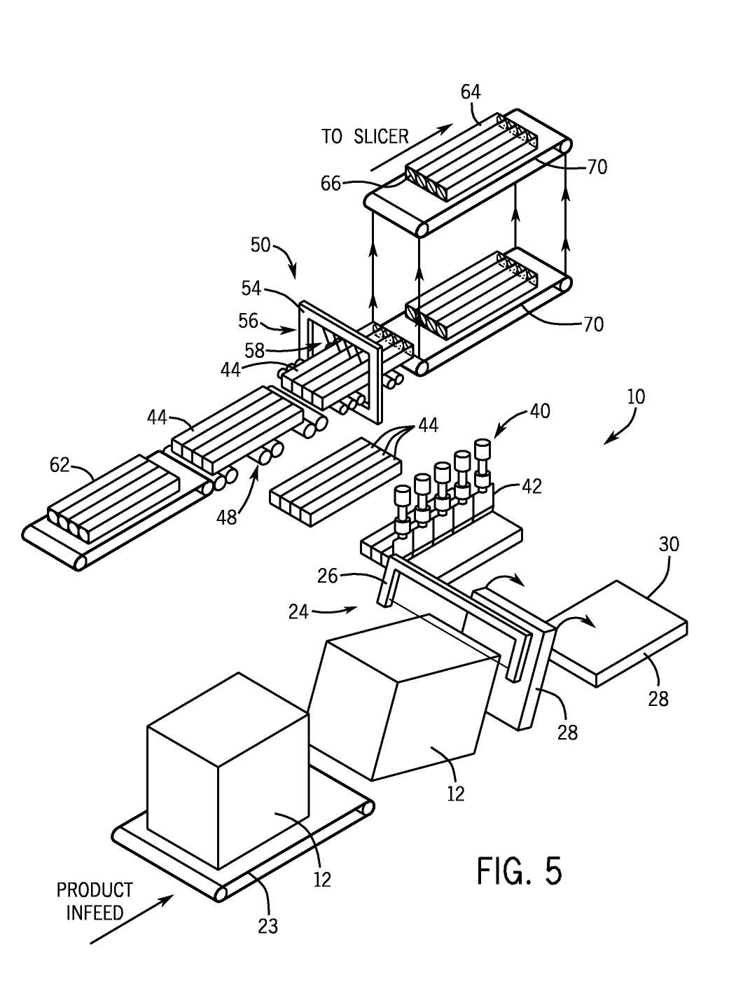

FIG. 6 is a partial perspective, schematic illustration of an exemplary embodiment of the cutter station of the profile loaf cutting system of FIG. 1 with a vertical cutter.

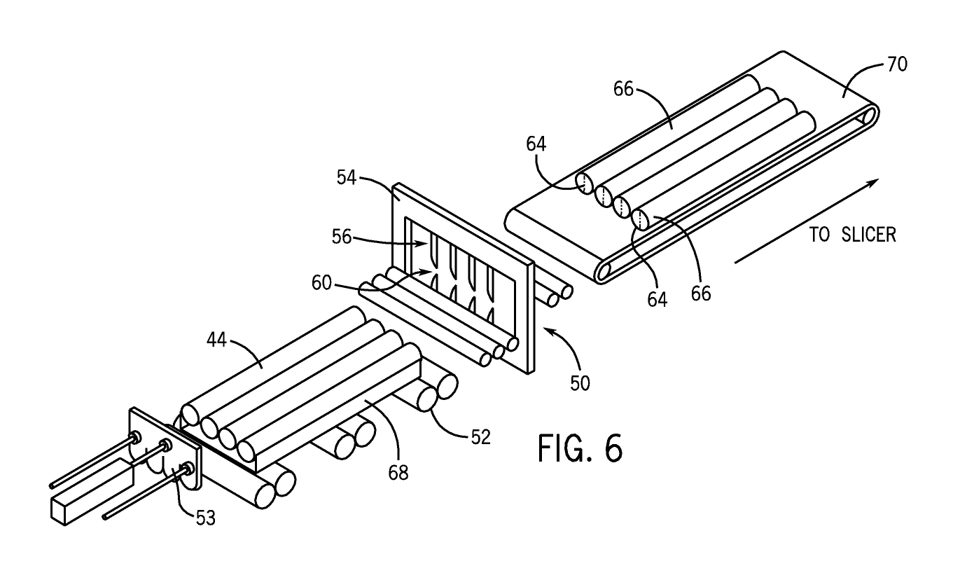

### DETAILED DESCRIPTION OF THE EXEMPLARY EMBODIMENTS

Cheese typically is produced in large blocks, cheese milk curd and other ingredients are poured into a bag lined mould, resulting in irregular surface features and rounded corners. The top surface of the block is typically formed by pressing plywood panel down onto the cheese curd in the box (mould) using springs. The springs are not equally tensioned which results in the block surface being uneven, sloped and irregular. This results in the leading edge of each bar cut from the block to have an irregular sloped leading face when presented to the food product optimizing process described herein.

Based on target product sizes the system determines the cut locations for each piece and communicates the cutting decision to the process control system for example a programmable logic controller 16 (PLC), for positioning and cutting with ultrasonic cutting knives and wire cutters.

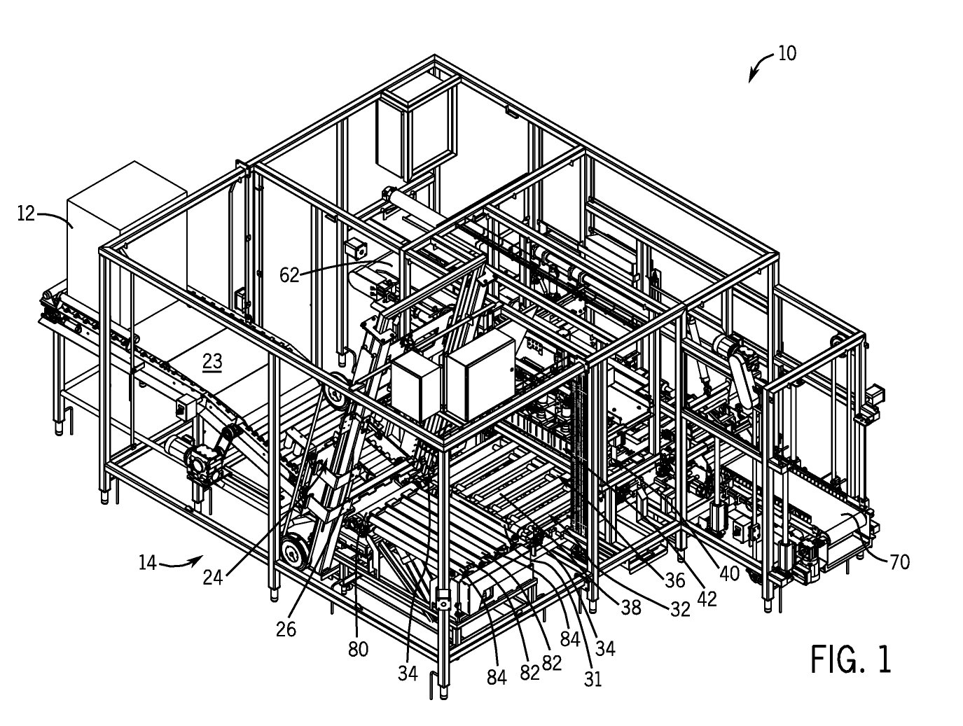

An exemplary embodiment of a system 10 for cutting blocks of a food product 12, for example cheese, into individual loaves of substantially equal size includes a plurality of conveyor belt (rollers) segments coupled together as illustrated in FIG. 1 and functioning as described below. The conveyor system segments comprising the plurality of stations 22 and platforms of the system 10 includes: slab cutter station 24, slab measuring system 32, indexing station 36, loaf cutter station 40, staging platform 48, profile cutter station 50, exit conveyor 70, and manual load in-feed platform 62.

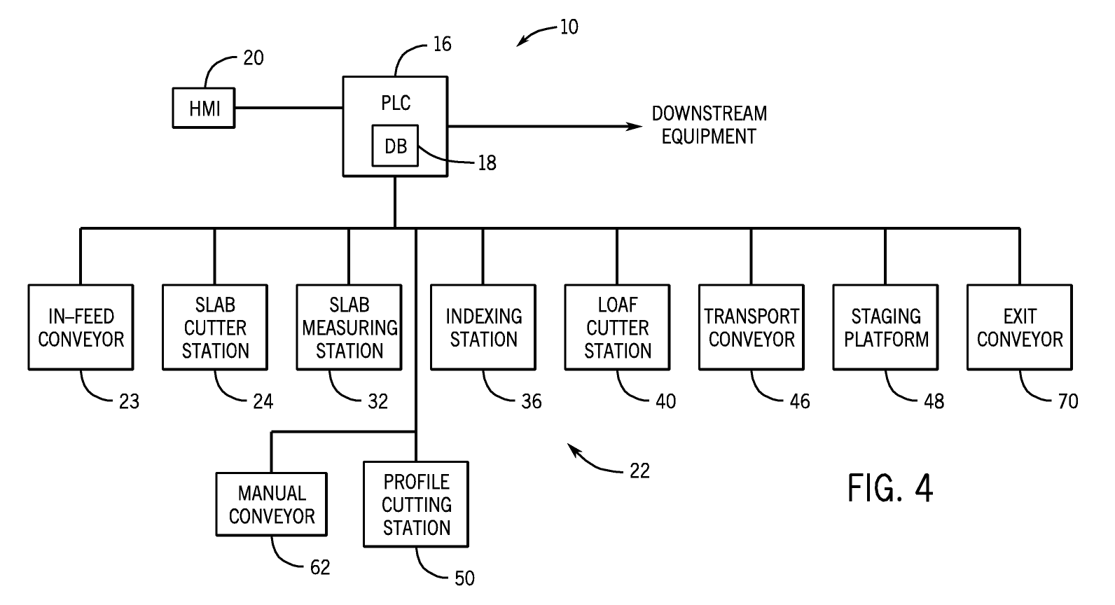

Referring to FIG. 4, a programmable logic controller (PLC) 16 such as a microprocessor, or other sustainable control device, controls the function and operation of the system for cutting blocks of food product 12 described herein. The PLC 16 functions in cooperation with various sensors and actuators positioned in the system 10. As described below, the PLC 16 determines an optimized cut solution for each slab portion 28 cut from the block of food product 12.

The optimized cut solution maximizes the number of individual loaves of food product having substantially equal size and minimizes the amount of waste for a specific slab portion 28 of food product.

The PLC 16 synchronizes the several operations of the plurality of stations 22 and platforms comprising the system 10. The PLC 16 controls and exchanges data with the several actuators, for example, servomotors (not shown), sensors (not shown), and the conveyor belts (rollers) in accord with the optimized cut solution determined by the PLC 16.

It should be understood that the cutter conveyor 14 described herein can be duplicated with the system 10 operating side-by-side in parallel. Each cutter conveyor 14 will include appropriate conveyor, sensor and cutters controlled by a separate PLC 16. It is also envisioned that one PLC can control both cutter conveyors.

The PLC 16 in an exemplary embodiment can be coupled to ethernet modules and the cutter conveyor 14. Data relating to the specific type of food product, such as cheese, is stored in a database 18 associated with the PLC 16. A suitable user interface 20 can be used to input, display and output data. Data can also be transmitted through various suitable ethernet ports 62 and uplink mechanisms.

A 640 pound block of food product 12, for example cheese, is loaded onto the in-feed conveyor belt 23 of the profile loaf food cutter. It should be understood that the typical nominal weight of the block of food product is 640 pounds, however the weight may range from 640 pounds to as much as 860 pounds (megablock) depending on the density and size of the food product. The feed block 12 will be aligned with, for example, either a 22 or 28 inch longitudinal dimension depending on the size of the finished cut. It should be understood that the food block 12 may be of any longitudinal dimension.

The PLC 16 will have a pre-selected distance stored in the database 18 which is used to index the food block 12 into the slab cutter station 24. The pre-selected distance will be the height of the elongated loaf 44. The PLC 16 will also have stored in the database 18 a pre-selected number of elongated loaves 44 that a given slab portion 28 will be cut. For example, if the finished cut is 4.4″ wide the block will be loaded with the 22″ side facing the wire cutter harp 26 resulting in 5 loaves, 28″ long. If the finished cut length is 5.6″ wide the block will be loaded with the 28″ side facing the wire cutter harp 26 resulting in 5 loaves, 22″ long.

The block 12 will index the pre-selected distance into the cut chamber of the slab cutter station 24 and wait for the lift table to be in position. When the lift table is aligned with the wire cutter harp 26 the block 12 will move forward until it comes in contact with the lift table. The lift table distance from the wire cutter harp 26 determines how thick the block 12 will be cut from the 640 pound block forming a slab 28 of food product. The thickness dimension is the height on the final piece size. The thickness is adjustable by a servo drive and is controlled from a programmable logic controller 16.

Once the block 12 is in position in the slab cutter station 24, i.e. indexed, to be cut a plurality of holding cylinders engage to hold the block in position. There are two hold cylinders on each side and one on the top of the block. Once the hold cylinders are in place the wire cutter harp 26 slowly begins moving into the food product (in the illustrated example the food product is a cheese block and will be referred to in this specification as “cheese”), once all the wire is in the cheese it will speed up to cut faster and then before it gets all the way through the cheese block 12 the wire slows down again. Such action prevents wire breakage and product blow out at the bottom of the cheese block 12. The wire cutter harp 26 carriage is servo driven to provide control over the speed of the wire.

When the wire gets through the cheese block the tilt table 80 lays the cut slab 28 onto the take away rollers or belts 84 and will remain there until the cheese slab is moved to the slab measuring station 32. The tilt table (also referred to as a slab rotating assembly) typically is composed of a plurality of elongated planar members 82 configured to position between and move below the table away rollers or belts 84 to position the slab 28 of food product on the take away rollers or belts. After the cheese slab 28 leaves the discharge belt the cycle starts all over again. The movement and actions are controlled by the PLC 16 based on information in its database 18.

The cheese slab 28 enters the slab measuring station 32 from the discharge conveyor of the slab cutter station 24. When the cheese slab 28 reaches a sensor, for example a photo eye associated with the measuring station 32, the belt moves slowly and then measures the slab 28 along a side 30 of the slab 28 and transmits the measured length to the PLC 16. The measuring station 22 is a servo driven belt or roller controlled by the PLC 16. It should be understood that the slab 28 can be held stationary while the photo eye or other suitable sensor is moved parallel to the side 30 of the slab 28 being measured to obtain the side length.

Optimization results in individual loaves 44 of food product of substantially equal size, with the most same size pieces within the size envelope restrictions that may have an allowable defect, but are gross defect free.

In an exemplary embodiment of the system 10, an optimized cut solution is a cutting list that can be communicated from the remote controller or the human machine interface 20 to the PLC 16, which includes the measured side 30 of the slab 28, the number of loaves to be cut from the given slab 28. Each cutting/piece index may include the calculated cutting index for the side 30 of the piece (cut location relative to the side edge of the slab).

The PLC 16 implements the cutting of all of the pieces from the slab 28. The PLC 16 receives or calculates the measured length of the side 30 of the slab portion 28 from the sensor at the slab measuring station 32. The database 18 of the PLC 16 includes a desired number of loaves to be cut from a given slab portion 28. The PLC 16 determines the width of each profile cut elongated loaf based on the measured length of the side 30 of the slab portion 28 and the predetermined number of desired loaves. An advantage of this system 10 is to minimize waste in the cutting of the slab portion.

The user interface and display 20 includes the measured length along the side 30 of the slab 28. The display is on a screen associated with the PLC 16. The display may be integral with the controller or remote from the controller.

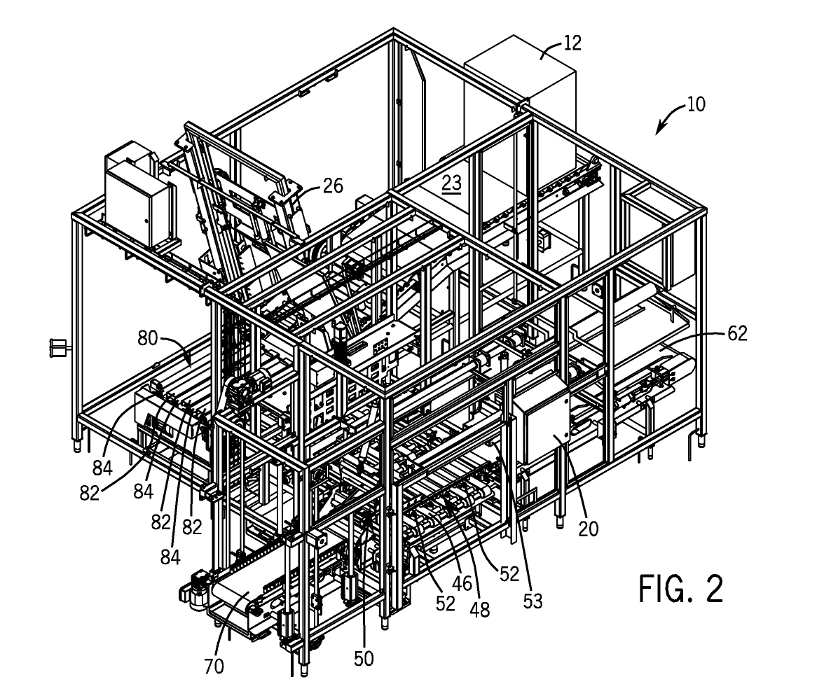

With the slab 28 measured rollers, belts or a pusher mechanism moves the slab 28 at a right angle to the slab cutting station 24 as illustrated in FIG. 2. The slab portion of cheese 28 is moved to a pair of vertical posts or a bar 31 used to square the slab relative to the loaf cutter station 40 on the indexing station 36. The vertical posts or bar 31 reciprocally move up and down relative to the conveyor mechanism by an actuator controlled by the PCL 16. After the slab portion 28 is aligned and squared the posts or bar is lowered allowing the slab 28 to continue moving into a set of blocks on the indexing station 36. The PLC 16 activates the indexing station 36 servo motors to move the leading edge of the slab portion 28 a given distance, as determined by the PLC 16 as described above, beyond the ultrasonic guillotine cutter and activates the guillotine cutter to cut an elongated loaf 44 from the slab portion 28. The calculations performed in the PLC 16 based on the measured side 30 of the slab portion 28 and the predetermined number of elongated loaves 44 to be cut from the slab, controls the guillotine cutter in the loaf cutter station 40 to cut the slab portion 28 into the number of equal width elongated loaves 44 as determined by the optimized cutting solution from the PLC 16. In such manner, the slab portion 28 is cut into a plurality of the same size elongated loaves 44 with no waste.

A transport conveyor 46 which may be composed of several sections or segments moves the equal size elongated loaves 44 that were cut from the slab portion 28, simultaneously as a group, to a staging platform 48 and held there until the loaves can be moved to the profile cutting station 50. When the profile cutting station 50 is clear, the staging platform 48 moves the group of elongated loaves 44 into position that is aligned with the profile cutting station 50. (See FIG. 2)

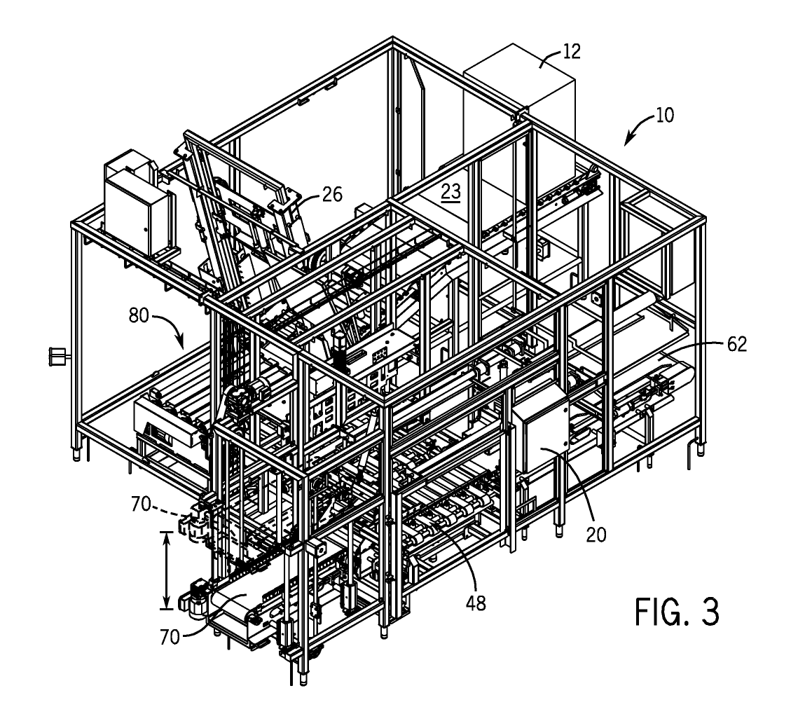

The profile cutting station 50 includes loaf conveyor belts or rollers 52, a loaf pusher 53, a cutter holder 54, and a profile cutter 56. When the group of elongated loaves 44 are positioned at the profile cutter station 50 the loaf pusher 53 moves the group of elongated loaves 44, simultaneously, through the cutter holder 54. The cutter holder 54 is configured to receive different cutters 56 as illustrated in FIGS. 2 and 3. In FIG. 2, the profile cutter 56 is a diagonal cutter 58 and cuts each of the elongated loaves 44 into a first profile cut elongated loaf 64 and a second profile cut elongated loaf 66 each having a triangular cross section. In another operation, the cutter holder 54 can receive a profile cutter 56 that is a vertical cutter 60 (See FIG. 3). The vertical cutter will cut, simultaneously, the elongated loaves 44 into a first profile cut 64 and a second profile cut 66. In the illustration in FIG. 3, the elongated loaves 44 have a circular cross section and upon receiving the vertical cut each half of the elongated loaf 44 (64, 66) will have a semi-circular cross section. Such cutting is typically used for provolone cheese. It should be understood that different shapes of the loaves can be obtained by different profile cutter configurations removably installed in the cutter holder 54 and cross-sectional shape of the elongated loaves 44 on the staging platform 48.

As illustrated in FIG. 3, the elongated loaves 44 are positioned on a contoured tray 68 and pushed by the loaf pusher 53 that has a corresponding contour. In the FIG. 3 illustrated example, the pusher 53 and tray 68 are configured with a semi-circle contour to accommodate the circular cross section of elongated loaves 44.

The profile cutter 56, as illustrated in FIGS. 2 and 3, may be a wire, a blade, or an ultrasound cutter or such other suitable cutting device as determined by user of the system for cutting blocks of food 10.

Upon leaving the profile cutter station 50 the elongated loaves 44 are moved to an exit conveyor and moved to further downstream processing equipment for preparing retail size food product and packaging. The exit conveyor 70 is configured to reciprocally move from a first position to a second position (see FIGS. 2 and 3) to align the exit conveyor 70 with the next food processing apparatus. The movement is produced by actuators controlled by the PLC 16. The profile cut elongated loaves 64, 63 move onto the exit conveyor 70 after passing through the profile cutter 56.

The system for cutting blocks of food 10 may also include a manual load in-feed platform or conveyors 62 as illustrated in FIGS. 1 and 2. With a manual load in-feed conveyor, smaller blocks of food, for example a 40 pound block of cheese or separate loaves of cheese such as provolone type can be introduced into the system 10. The manual in-feed conveyor 62 moves the food product onto the staging platform 48 to be moved to the profile cutter station 50 as described above.

It should be understood that the data transfer for the various sensors, photo cells, servo motors, cutters 26, 42, 56, conveyors and belts, and the PLC 16 can be by any suitable and reliable means, for example by hard-wire connection, ethernet transmission, wireless RF or microwave transmission or by optical communication as determined by a manufacturer or user of the system 10.

The system, and its various stations, conveyors, belts, and supporting structure are constructed and composed of material that is suitable for handling food products, such as stainless steel, thermoplastic bearings, urethane transfer belts, with all product contact surfaces having a number 4 finish and all the framework and non-food contact surfaces having a glass bead finish. Actuators can be of pneumatic rodless cylinders and guide rods or can be electrical servomotors as determined by manufacturer or user of the system 10. Hydraulic actuators typically are not used.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the present profile loaf cutting system has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the exact weight cutting system as described herein may be made, none of which depart from the spirit or scope of the present disclosure. The particular embodiments and applications were chosen and described to provide the best illustration of the principles of the cutting system and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A process for automating cutting of a block of food into individual elongated loaves on a conveyor system including an in-feed conveyor, a wire harp cutter, an indexing platform, and a guillotine cutter, the process comprising:
moving a food block on the in-feed conveyor to the wire harp cutter;
indexing the food block in the wire harp cutter a pre-selected distance;
cutting a slab of the food block at the indexed distance;
rotating the slab 90° onto the indexing platform;
determining with a sensor a slab width dimension of the slab;
transmitting the slab width dimension to a programmable logic controller coupled to the conveyor system;
cutting the slab with the guillotine cutter into a preselected number of elongated loaves, with each loaf having a loaf width dimension equal to the slab width dimension divided by the preselected number of elongated loaves; and
moving the elongated loaves to a cutting station,
wherein the process for automating cutting of a block of food is controlled by the PLC, the PLC including a database storing the pre-selected distance, the pre-selected number, and the slab width dimension.

2. The process for automating cutting of a block of food into individual elongated loaves of claim 1, further comprising:
moving the elongated loaves to a staging platform coupled to the cutting station;
inserting a cutter into a cutter holder positioned traverse to a longitudinal axis of the elongated loaves;
moving the elongated loaves through the cutter to a second staging platform;
wherein each elongated loaf is cut in a pre-selected profile.

3. The process for automating cutting of a block of food into individual elongated loaves of claim 2, wherein the cutter is one of a diagonal cutter and a vertical cutter.

4. The process for automating cutting of a block of food into individual elongated loaves of claim 3, wherein one of the diagonal cutter and the vertical cutter is a wire.

5. The process for automating cutting of a block of food into individual elongated loaves of claim 2, wherein the staging platform further comprises a contoured tray configured to support a plurality of elongated loaves of food product.

6. The process for automating cutting of a block of food into individual elongated loaves of claim 1, wherein the cutter station further comprises a manual loaf in-feed platform.

7. The process for automating cutting of a block of food into individual elongated loaves of claim 1, wherein the food block is cheese.

8. A process for automating cutting of a block of food into individual elongated loaves on a conveyor system including an in-feed conveyor, a wire harp cutter, an indexing platform, and a guillotine cutter, the process comprising:
moving a food block on the in-feed conveyor to the wire harp cutter;
indexing the food block in the wire harp cutter a pre-selected distance;
cutting a slab of the food block at the indexed distance;
rotating the slab 90° onto the indexing platform;
determining with a sensor a slab width dimension of the slab;
transmitting the slab width dimension to a programmable logic controller coupled to the conveyor system;
cutting the slab with the guillotine cutter into a preselected number of elongated loaves, with each loaf having a loaf width dimension equal to the slab width dimension divided by the preselected number of elongated loaves;
moving the elongated loaves to a staging platform coupled to a cutting station;
inserting a cutter into a cutter holder coupled to the cutting station, the cutter positioned traverse to a longitudinal axis of the elongated loaves;
moving the elongated loaves through the cutter, wherein each elongated loaf is cut in a pre-selected profile;
moving each profile cut elongated loaf to a second staging platform,
wherein the process for automating cutting of a block of food is controlled by the PLC, the PLC including a database storing the pre-selected distance, the pre-selected number, and the slab width dimension.

9. The process for automating cutting of a block of food into individual elongated loaves of claim 8, wherein the cutter is one of a diagonal cutter and a vertical cutter.

10. The process for automating cutting of a block of food into individual elongated loaves of claim 9, wherein one of the diagonal cutter and the vertical cutter is a wire.

11. The process for automating cutting of a block of food into individual elongated loaves of claim 8, wherein the staging platform further comprises a contoured tray configured to support a plurality of elongated loaves of food product.

12. The process for automating cutting of a block of food into individual elongated loaves of claim 8, wherein the cutter station further comprises a manual loaf in-feed platform.

13. The process for automating cutting of a block of food into individual elongated loaves of claim 8, wherein the food block is cheese.

14. A system for cutting blocks of food product into individual, elongated loaves, the system comprising:
a loaf cutter conveyor configured to receive incoming blocks of food product and move the blocks along a continuum processing path for cutting;
a programmable logic controller coupled to the loaf cutter conveyor; and
a plurality of stations associated with the loaf cutter conveyor with each station coupled to the programmable logic controller, the stations comprising:
a slab cutter station configured to cut a slab portion from a block of food product;
a slab measuring station configured to determine a length of a side of the slab portion;
an indexing station configured position the slab portion;
a loaf cutter station configured to cut the slab portion into a preselected number of elongated loaves of substantially equal width; and
a transport conveyor configured to move the elongated loaves away from the loaf cutter station,
wherein the programmable logic controller is configured to control the cutting of the food product into individual elongated loaves of
substantially equal width.

15. The system for cutting blocks of food product into individual, elongated loaves of claim 14 further comprising:
a staging platform aligned with the transport conveyor and configured to receive the plurality of elongated loaves of food product;
a profile cutter station coupled to the staging platform, the profile cutter station including a loaf conveyor and a cutter holder positioned traverse to the loaf conveyor;
a profile cutter disposed in the cutter holder; and
a second staging platform coupled to the profile cutter station and configured to receive profile cut elongated loaves of food product,
wherein the loaf conveyor is configured to move, simultaneously, the plurality of elongated loaves through the profile cutter to cut each elongated loaf into a least two profile cut elongated loaves and onto the second staging platform.

16. The system for cutting blocks of food product into individual, elongated loaves of claim 15, wherein the profile cutter is one of a diagonal cutter and a vertical cutter.

17. The system for cutting blocks of food product into individual, elongated loaves of claim 16, wherein one of the diagonal cutter and the vertical cutter is a wire.

18. The system for cutting blocks of food product into individual, elongated loaves of claim 15, wherein the staging platform further comprises a contoured tray configured to support a plurality of elongated loaves of food product.

19. The system for cutting blocks of food product into individual, elongated loaves of claim 14, wherein the cutter station further comprises a manual loaf in-feed platform.

20. The system for cutting blocks of food product into individual, elongated loaves of claim 14, wherein the food block is cheese.

21. A system for cutting blocks of food product into individual, profiled elongated loaves, the system comprising:
a conveyor system configured with a plurality of stations and platforms, with a station each to cut a slab portion, measure a length of a side of the slab portion, position the slab portion, cut the slab portion into a plurality of elongated loaves of substantially equal width, stage the elongated loaves, cut the elongated loaves into a preselected profile with a removable cutter, move the profile cut elongated loaves; and
a programmable logic controller coupled to the conveyor system and configured to control each of the stations and platforms, the programmable logic controller also configured to determine the width of each profile cut elongated loaf based on the length of the side of the slab portion of food product and a predetermined number of desired loaves,
wherein each of the profiled cut elongated loaves is substantially the same width.

22. The system for cutting blocks of food product into individual, profiled elongated loaves of claim 21, wherein the removable cutter is one of a diagonal cutter and a vertical cutter.

23. The system for cutting blocks of food product into individual, profiled elongated loaves of claim 22, wherein one of the diagonal cutter and the vertical cutter is a wire.

24. The system for cutting blocks of food product into individual, profiled elongated loaves of claim 21, the conveyor system further comprising: a contoured tray configured to support a plurality of elongated loaves of food product.

25. The system for cutting blocks of food product into individual, profiled elongated loaves of claim 21, the cutter station further comprising: a manual loaf in-feed platform.

26. The system for cutting blocks of food product into individual, profiled elongated loaves of claim 21, wherein the food block is cheese.
